(19) United States
(12) Patent Application Publication
(10) Pub. No.: US 2024/0187103 A1
(43) Pub. Date: Jun. 6, 2024

(54) OPTICAL SIGNAL RELAY APPARATUS, OPTICAL TRANSMISSION SYSTEM, AND OPTICAL SIGNAL RELAY METHOD

(71) Applicant: NEC Corporation, Tokyo (JP)

(72) Inventor: Toshifumi Nakamura, Tokyo (JP)

(73) Assignee: NEC Corporation, Tokyo (JP)

(21) Appl. No.: 18/526,369

(22) Filed: Dec. 1, 2023

(30) Foreign Application Priority Data
Dec. 6, 2022 (JP) 2022-195197

(51) Int. Cl. H04B 10/572; H04B 10/58

(52) U.S. Cl. CPC H04B 10/572; H04B 10/58

(57) ABSTRACT

The optical signal relay apparatus according to the present disclosure includes: a wavelength selective switch unit configured to, when a same-wavelength optical signal having the same wavelength as a wavelength included in a second optical signal is present in a wavelength included in a first optical signal, separate the same-wavelength optical signal; a wavelength conversion unit configured to convert the wavelength of the same-wavelength optical signal into a different wavelength; an optical compensation unit configured to compensate for a predetermined distortion being generated when the wavelength of the same-wavelength optical signal is converted into the different wavelength; and a control unit configured to acquire the predetermined distortion, based on a database that stores in advance a relationship among the wavelength conversion, a distortion being generated at a time of the wavelength conversion, and a transmission rate of an optical signal.

### INCORPORATION BY REFERENCE

This application is based upon and claims the benefit of priority from Japanese patent application No. 2022-195197, filed on Dec. 6, 2022, the disclosure of which is incorporated herein in its entirety by reference.

### TECHNICAL FIELD

The present disclosure relates to an optical signal relay apparatus, an optical transmission system, an optical signal relay method, and a program, and more particularly, to an optical signal relay apparatus, an optical transmission system, an optical signal relay method, and a program that are capable of improving communication quality of a wavelength-multiplexed optical signal.

### BACKGROUND ART

A ring network adopted in a metro area is constituted of a reconfigurable optical add/drop multiplexer (ROADM) that connects optical signals by using a wavelength selective switch (WSS) and reproduces and relays the optical signals with electric signals once demodulated by using a transponder. In optical communication using optical signals subjected to wavelength division multiplexing (WDM), optical communication using the same wavelength may be performed in a case of different nodes in the same network, but cannot coexist in a case of the same node. Therefore, the ROADM employs a digital transceiver (TRX) that, when converting an optical signal into an electric signal, reproducing and relaying the electric signal, and re-converting into the optical signal, performs conversion in such a way that the wavelength becomes different (a different wavelength) from a wavelength before conversion. However, in electric regeneration relaying including demodulation, for example, digital signal processing by a field programmable gate array (FPGA) is required, resulting in problems that power consumed by the digital signal processing is large, and a cost of the FPGA is high.

Therefore, in the ROADM, analog wavelength conversion that does not demodulate an optical signal has been studied. Since the analog wavelength conversion does not require digital signal processing, it is possible to reduce power consumption and decrease a cost by not using the FPGA. However, in the analog wavelength conversion, since regenerating and retiming cannot be performed, there is a problem that a re-converted optical signal is deteriorated and spectral distortion is generated and propagated.

As a solution to the above-described problem, paragraph and FIG. 7 of Patent Literature 1 (Japanese Unexamined Patent Application Publication No. 2019-220773) describes, “since a reception light wavelength from an SDN controller becomes the reception light wavelength, a reception-side CPU in a receiver controls a local light source in such a way as to shift the local light emission wavelength to the reception light wavelength. As a result, even when a signal light after wavelength conversion in a wavelength converter or the like greatly exceeds a channel grid due to wavelength shift or the like, the shift between the local emission wavelength and the received light wavelength is eliminated, thereby deterioration of reception quality of each receiver may be suppressed.” Patent Literature 1 does not disclose compensating for spectral distortion being generated when re-converting the wavelength of an optical signal into a different wavelength.

### SUMMARY

As described above, since regenerating and retiming cannot be performed in the analog wavelength conversion, there is a problem that spectral distortion occurs when conversion is performed again to another wavelength, and communication quality deteriorates.

An example object of the present disclosure is to provide an optical signal relay apparatus, an optical transmission system, an optical signal relay method, and a program that solve the above-described problem.

In a first example aspect of the present disclosure, an optical signal relay apparatus includes:
an input unit including a first input terminal to which a first optical signal including at least one wavelength is input via a first transmission line, and a second input terminal to which a second optical signal including at least one wavelength is input via a second transmission line;
a wavelength selective switch unit configured to, when a same-wavelength optical signal having the same wavelength as a wavelength included in the second optical signal is present in a wavelength included in the first optical signal, separate the same-wavelength optical signal;
a wavelength conversion unit configured to convert the wavelength of the same-wavelength optical signal into a different wavelength;
an optical compensation unit configured to compensate for a predetermined distortion being generated when converting the wavelength of the same-wavelength optical signal into the different wavelength;
a control unit configured to acquire the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and control the optical compensation unit in such a way as to compensate for the predetermined distortion; and
an output unit configured to output a different-wavelength optical signal including the different wavelength after the predetermined distortion is compensated.

In a second example aspect of the present disclosure, an optical transmission system includes an optical signal relay apparatus and a storage device configured to store information relating to a distortion being generated at a time of wavelength conversion,
the optical signal relay apparatus includes
   an input unit including a first input terminal to which a first optical signal including at least one wavelength is input via a first transmission line, and a second input terminal to which a second optical signal including at least one wavelength is input via a second transmission line,
   a wavelength selective switch unit configured to, when a same-wavelength optical signal having the same wavelength as a wavelength included in the second optical signal is present in a wavelength included in the first optical signal, separate the same-wavelength optical signal,
   a wavelength conversion unit configured to convert the wavelength of the same-wavelength optical signal into a different wavelength,
   an optical compensation unit configured to compensate for a predetermined distortion being generated when converting the wavelength of the same-wavelength optical signal into the different wavelength,
   a control unit configured to acquire the predetermined distortion, based on a database that stores in advance a relationship among the wavelength conversion, a distortion being generated at a time of wavelength conversion, and a transmission rate of an optical signal, the wavelength of the same-wavelength optical signal, the different wavelength, and the transmission rate of the same-wavelength optical signal, and control the optical compensation unit in such a way as to compensate for the predetermined distortion, and
   an output unit configured to output a different-wavelength optical signal including the different wavelength after the predetermined distortion is compensated, and
the storage device stores, in the database in advance, a relationship among the wavelength conversion, a distortion being generated at a time of the wavelength conversion, and the transmission rate of an optical signal.

In a third example aspect of the present disclosure, an optical signal relay method includes:
separating, when a same-wavelength optical signal having the same wavelength as a wavelength included in a second optical signal including at least one wavelength is present in a wavelength included in a first optical signal including at least one wavelength, the same-wavelength optical signal;
converting a wavelength of the same-wavelength optical signal into a different wavelength;
compensating for a predetermined distortion being generated when converting the wavelength of the same-wavelength optical signal into the different wavelength;
acquiring the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and performing control in such a way as to compensate for the predetermined distortion; and
outputting a different-wavelength optical signal including the different wavelength after the predetermined distortion is compensated.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating an example of an optical signal relay apparatus according to a first example embodiment:

FIG. 2 is a block diagram illustrating an example of an optical transmission system according to the first example embodiment:

FIG. 3 is a diagram illustrating an example of a database according to the first example embodiment:

FIG. 4 is a graph illustrating examples of effects of the optical signal relay apparatus according to the first example embodiment:

FIG. 5 is a diagram illustrating an example of the database according to the first example embodiment:

FIG. 6 is a block diagram illustrating an example of the optical signal relay apparatus according to the first example embodiment:

FIG. 7A is a flowchart illustrating an example of an operation of the optical signal relay apparatus according to the first example embodiment:

FIG. 7B is a flowchart illustrating an example of an operation of the optical signal relay apparatus according to the first example embodiment:

FIG. 7C is a flowchart illustrating an example of an operation of the optical signal relay apparatus according to the first example embodiment:

FIG. 8 is a block diagram illustrating an example of an optical signal relay apparatus according to a second example embodiment:

FIG. 9 is a block diagram illustrating an example of an optical signal relay apparatus according to a third example embodiment; and

FIG. 10 is a block diagram illustrating an example of an optical signal relay apparatus according to a modified example of the third example embodiment.

### EXAMPLE EMBODIMENT

Hereinafter, example embodiments of the present disclosure will be described with reference to the drawings. In the drawings, the same or corresponding element is denoted by the same reference numeral, and redundant descriptions are omitted as necessary for clarity of description.

### First Example Embodiment

### <Optical Signal Relay Apparatus, Optical Transmission System>

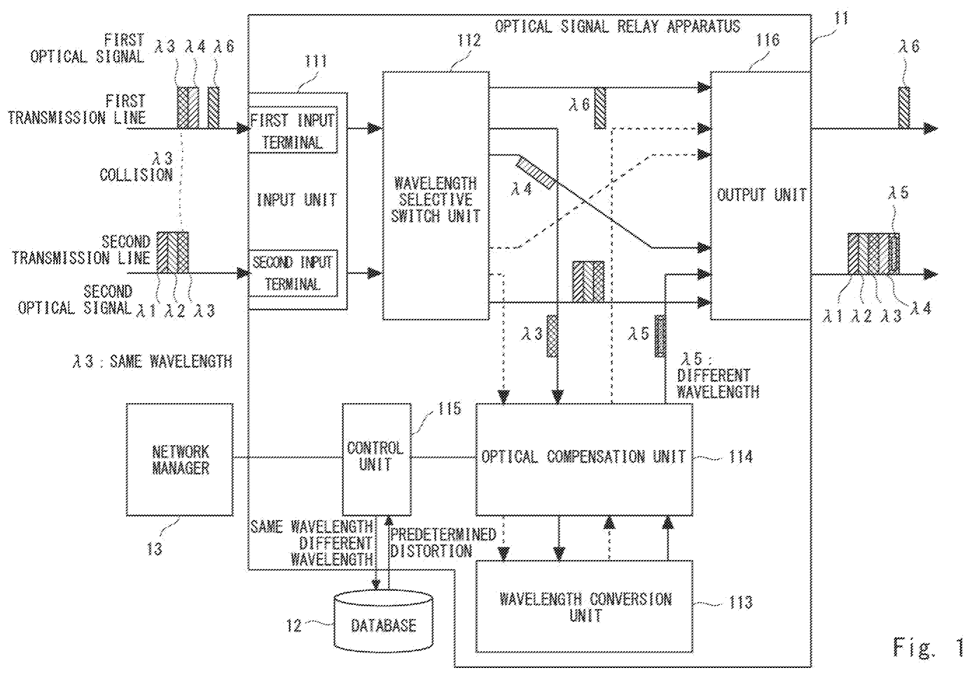

FIG. 1 is a block diagram illustrating an example of an optical signal relay apparatus according to a first example embodiment.

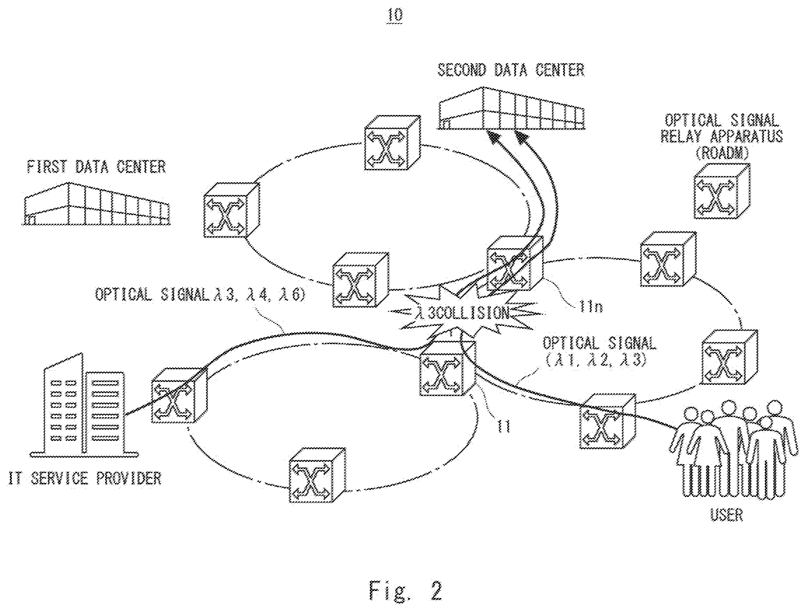

FIG. 2 is a block diagram illustrating an example of an optical transmission system according to the first example embodiment.

In FIG. 2, a storage device and a network manager are omitted for the sake of simplicity.

As illustrated in FIGS. 1 and 2, an optical transmission system 10 according to the first example embodiment includes an optical signal relay apparatus 11 and a storage device 12 that stores information relating to distortions being generated when performing wavelength conversion. The distortion may also be referred to as a spectral distortion.

The optical signal relay apparatus 11 includes an input unit 111, a wavelength selective switch unit 112, a wavelength conversion unit 113, an optical compensation unit 114, a control unit 115, and an output unit 116. Wavelength selective switching may also be referred to as WSS (wavelength selective switch).

The input unit 111 has a first input terminal to which a first optical signal including at least one wavelength is input via a first transmission line, and a second input terminal to which a second optical signal including at least one wavelength is input via a second transmission line. In FIG. 1, optical signals having a wavelength λ3, a wavelength λ4, and a wavelength λ6 are illustrated as the first optical signal, and optical signals having a wavelength λ1, a wavelength λ2, and a wavelength λ3 are illustrated as the second optical signal. Note that the first optical signal and the second optical signal are coherent light.

When a same-wavelength optical signal having the same wavelength as a wavelength included in the second optical signal is present in the wavelength included in the first optical signal, the wavelength selective switch unit 112 separates the same-wavelength optical signal. In the present example, the same-wavelength optical signal is an optical signal having a wavelength λ3. Therefore, the wavelength selective switch unit 112 separates (branches) the optical signal having the wavelength λ3.

The wavelength conversion unit 113 converts the wavelength of the same-wavelength optical signal into a different wavelength. The different wavelength is a wavelength other than the wavelength of the first optical signal or the wavelength of the second optical signal. In the present example, among the first optical signal and the second optical signal, the wavelength λ3 collides as the same-wavelength optical signal, and thus the wavelength is converted into the wavelength λ5 (different wavelength). Then, when the wavelength λ3 is converted into the wavelength λ5, a predetermined distortion (spectral distortion) is generated.

### <Spectral Distortion Compensation>

Herein, a method of compensating for a predetermined distortion (spectral distortion) being generated when converting the wavelength λ3 to the wavelength λ5 is described below.

First, the control unit 115 acquires information relating to the wavelength of the same-wavelength optical signal, information relating to a different wavelength, and a transmission rate of the same-wavelength optical signal from a network manager 13 which holds information relating to wavelengths of optical signals being used in the transmission line of the entire optical network. Since the network manager 13 holds information relating to a wavelength of an optical signal being used in each transmission line of the optical network, a distance of each transmission line, a transmission rate of an optical signal, the type of the optical fiber of each transmission line, and the like, it is possible to provide the control unit 115 of the optical signal relay apparatus 11 with information relating to the wavelength of the same-wavelength optical signal in any transmission line, information relating to the different wavelength, and the transmission rate of the same-wavelength optical signal.

For example, the control unit 115 acquires, from the network manager 13, a wavelength λk as the wavelength of the same-wavelength optical signal, a wavelength λm as the different wavelength, and a transmission rate s as the transmission rate of the same-wavelength optical signal. Note that, the optical signal relay apparatus 11 may acquire, from the network manager 13, information relating to a transmission line (collision route) in which optical signals of the same wavelength collide with each other.

Next, the control unit 115 accesses a database (DB).

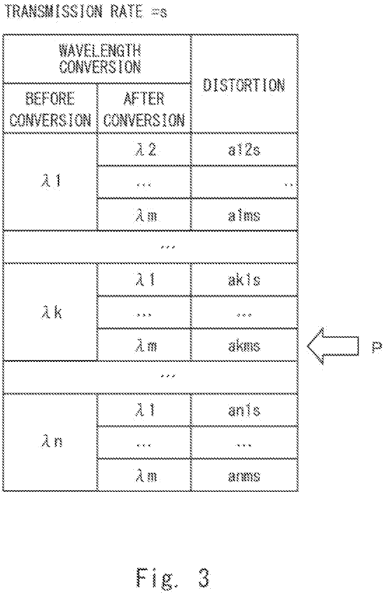

FIG. 3 is a diagram illustrating an example of a database according to the first example embodiment.

Herein, n and m are integers, and k is an integer of 2 to (n−1).

FIG. 3 illustrates information regarding spectral distortion.

As illustrated in FIG. 3, in the database, a relationship between a wavelength before wavelength conversion, a wavelength after wavelength conversion, a distortion being generated at the time of wavelength conversion, and a transmission rate of an optical signal is stored in advance (the database stores a relationship between wavelength conversion, a distortion being generated at the time of wavelength conversion, and a transmission rate of an optical signal). For example, when the wavelength before the wavelength conversion is the wavelength λ1, the wavelength after the wavelength conversion is the wavelength λ2, and the transmission rate of the optical signal is s, the distortion being generated at the time of the wavelength conversion is a12s. Such data is measured in advance by an experiment or the like, and the measurement result is stored in the database. Specifically, the difference between the spectra before and after the wavelength conversion is measured and stored as spectral distortion by using a reference signal.

Although FIG. 3 illustrates only a case where the transmission rate is s, the present disclosure is not limited thereto. Cases where the transmission rate is other than s are also stored in the database. In FIG. 3, transmission rates other than s are omitted for the sake of simplicity.

When, from the network manager 13, the wavelength λk as the wavelength of the same-wavelength optical signal, the wavelength λm as the different wavelength, and the transmission rate s as the transmission rate of the same-wavelength optical signal are acquired, the control unit 115 compares the information relating to the acquired items and the information stored in the database (indicated by an arrow P in FIG. 3), and determines that the spectral distortion generated in this case is a distortion akms. The control unit 115 controls the optical compensation unit 114 in such a way as to compensate for the distortion akms.

That is, the control unit 115 acquires a predetermined distortion (distortion akms in FIG. 3), based on the database, the wavelength of the same-wavelength optical signal, the different wavelength, and the transmission rate of the same-wavelength optical signal, and controls the optical compensation unit 114 in such a way as to compensate for the predetermined distortion akms.

The optical compensation unit 114 compensates for a predetermined distortion being generated when the wavelength of the same-wavelength optical signal is converted into the different wavelength under the control of the control unit 115. The optical compensation unit 114 compensates for the predetermined distortion by using a plurality of compensators. A compensator for compensating for spectral distortion (predetermined distortion) and using a database may be referred to as a spectral compensation filter.

The output unit 116 outputs a different-wavelength optical signal including the different wavelength after a predetermined distortion is compensated.

The storage device 12 stores in the database in advance a relationship between the wavelength conversion, the distortion being generated at the time of the wavelength conversion, and the transmission rate of the optical signal. The database may also store in advance a relationship between a modulation method for modulating the optical signal and the distortion being generated.

Further, the optical signal relay apparatus 11 may further include an optical wavelength detection unit (not illustrated) that detects whether the same-wavelength optical signal is present in the wavelengths included in the first optical signal. By collating the information detected by the optical wavelength detection unit with the information acquired from the database, it is possible to reliably detect the presence or absence of the same-wavelength optical signal.

### <Effect>

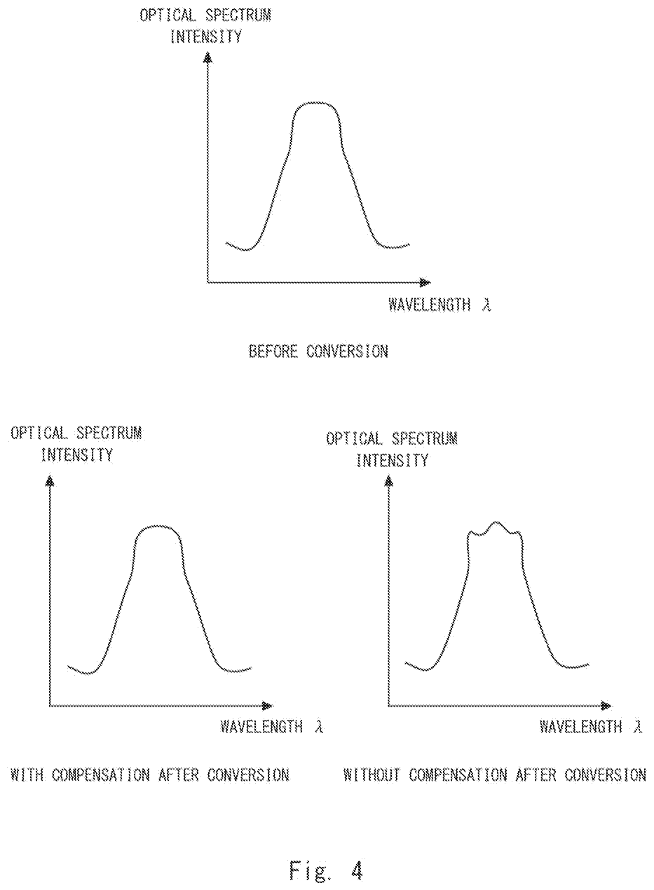

FIG. 4 is a graph illustrating examples of effects of the optical signal relay apparatus according to the first example embodiment.

In FIG. 4, the horizontal axis represents a wavelength, and the vertical axis represents an optical spectrum intensity.

The optical signal relay apparatus 11 according to the first example embodiment converts the wavelength of the same-wavelength optical signal into the different wavelength in order to avoid collision of the same wavelength. At this time, a predetermined distortion is generated, but the optical signal relay apparatus 11 compensates for the predetermined distortion. Thus, for example, a spectral waveform of an optical signal before conversion in FIG. 4 is converted into a spectrum of the optical signal with compensation after conversion.

Meanwhile, when there is no distortion compensation, for example, the spectral waveform of the optical signal before conversion in FIG. 4 is converted into a spectrum of the optical signal without compensation after conversion. Comparing the graph with compensation after conversion and the graph without compensation after conversion, it can be understood that the predetermined distortion is reduced in the graph with compensation after conversion. Therefore, according to the first example embodiment, it is possible to provide an optical signal relay apparatus, an optical transmission system, an optical signal relay method, and a program capable of improving the communication quality of a wavelength-multiplexed optical signal.

Further, according to the first example embodiment, by compensating the spectral distortion being generated at the time of wavelength conversion by using a compensator, it is possible to improve the quality of the optical signal and extend the communicable distance (transmission distance).

### <Correction of Chromatic Dispersion>

Herein, a method of compensating for a predetermined dispersion (chromatic dispersion) generated due to an optical signal being transmitted through an optical fiber is described below.

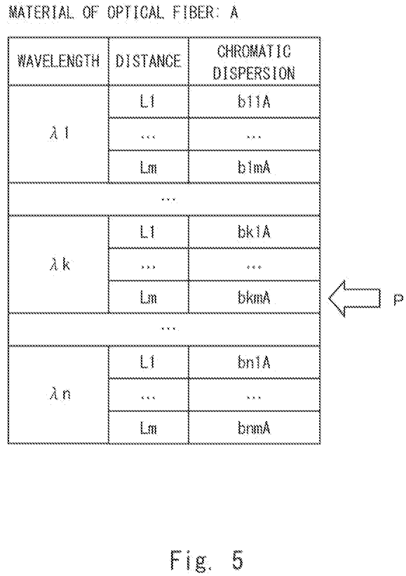

FIG. 5 is a diagram illustrating an example of a database according to the first example embodiment.

FIG. 5 illustrates information relating to chromatic dispersion.

Chromatic dispersion may be acquired based on the type (material) of the optical fiber used in the transmission line and the transmission distance. Therefore, the relationship between the wavelength of the optical signal, the transmission distance, the material of the transmission line (optical fiber), and the chromatic dispersion is acquired in advance. As illustrated in FIG. 5, the storage device 12 stores the relationship between the wavelength of the optical signal, the transmission distance, the material of the transmission line (optical fiber), and the chromatic dispersion in a database. For example, when the wavelength is the wavelength λ1, the transmission distance is the distance L1, and the material of the transmission line (optical fiber) is A, the storage device 12 stores in the database that the chromatic dispersion is b11A. Such data are measured in advance by an experiment or the like, and the storage device 12 stores the measurement result in the database. Note that, there may be cases where the transmission distance of the optical signal is defined as a route length, and the material of the fiber (transmission line) is defined as a fiber type.

Although FIG. 5 illustrates only a case where the material of the transmission line is A, the present disclosure is not limited thereto. Cases where the material of the transmission line is other than A are also stored in the database. In FIG. 5, materials of the transmission line other than A are omitted for the sake of simplicity.

The control unit 115 acquires, from the network manager 13, transmission line information including a distance of a transmission section from the optical signal relay apparatus 11 to another optical signal relay apparatus 11n (for example, illustrated in FIG. 2). When the wavelength λk as the wavelength of the optical signal, the distance Lm as the transmission distance (the distance of the transmission section), and the material A as the material of the transmission line are acquired, the control unit 115 compares the information relating to the acquired items with the information stored in the database (indicated by an arrow P in FIG. 4), and determines that the predetermined chromatic dispersion being generated in the transmission section in this case is a chromatic dispersion bkmA. The control unit 115 controls the optical compensation unit 114 in such a way as to compensate for the predetermined chromatic dispersion bkmA. Note that, the wavelength λk of the optical signal is a wavelength after wavelength conversion, that is, a different wavelength.

### <Effect>

The optical signal relay apparatus 11 may also compensate for a predetermined chromatic dispersion. Thus, the communication quality of the wavelength-multiplexed optical signal may be further improved as compared with the case where only the spectral distortion is compensated.

Further, according to the first example embodiment, it is possible to reduce the peak-to-average power ratio (PAPR) by compensating for the chromatic dispersion generated by the optical signal transmitting through the optical fibers by using a dispersion compensator. As a result, the use efficiencies of an amplifier (transimpedance amplifier (TIA)) of an optical reception FE and an amplifier of an optical transmission FE is increased, and the linearity of the amplifier is increased, thereby the third-order intermodulation distortion of the amplifier is less likely to occur. As a result, the transmission distance of the optical signal may be increased.

### <Details of Configuration of Optical Signal Relay Apparatus>

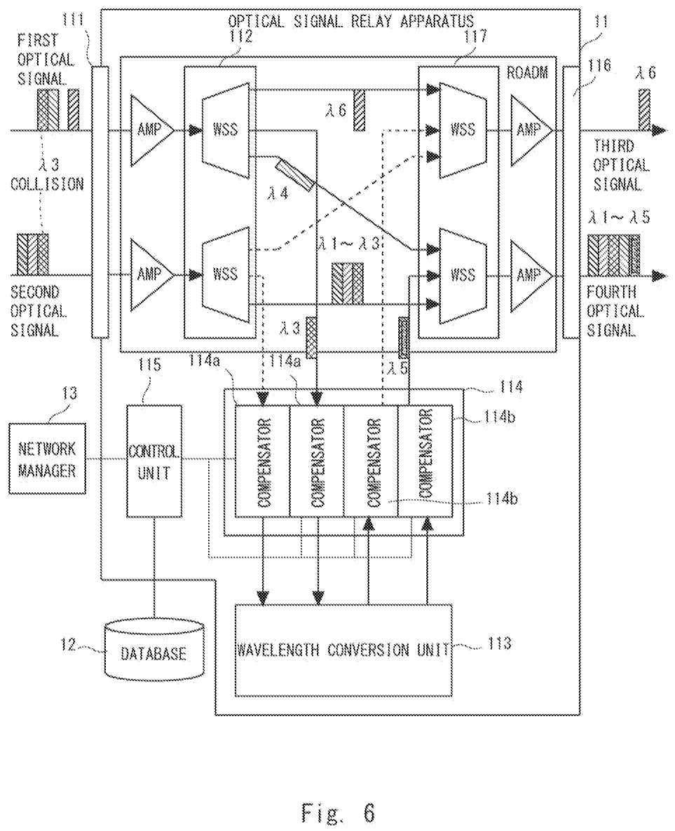

FIG. 6 is a block diagram illustrating an example of an optical signal relay apparatus according to the first example embodiment.

FIG. 6 illustrates details of the optical signal relay apparatus illustrated in FIG. 1.

As illustrated in FIG. 6, the optical signal relay apparatus 11 may further include a wavelength combining switch unit 117. The wavelength combining switch unit 117 combines wavelengths of a part of the first optical signal and a part of the second optical signal to generate a third optical signal, and combines another part of the first optical signal and another part of the second optical signal to generate a fourth optical signal. In the present example, the wavelength combining switch unit 117 generates an optical signal having the wavelength λ6 as the third optical signal, and combines the wavelengths λ1 to λ3, the wavelength λ4, and the wavelength λ5 (different wavelength) to generate the fourth optical signal.

The output unit 116 includes a third terminal for outputting the third optical signal and a fourth terminal (not illustrated) for outputting the fourth optical signal. The different-wavelength optical signal is included in at least one of the third optical signal and the fourth optical signal, and in the present example, the optical signal of the different wavelength λ5 after the wavelength conversion is included in the fourth optical signal.

The optical compensation unit 114 includes compensators 114a and 114b. The compensator 114a compensates for a predetermined distortion, after the wavelength selective switch unit 112 separates the same-wavelength optical signal and before the wavelength conversion unit 113 performs wavelength conversion. The compensator 114b compensates for a predetermined distortion, after the wavelength conversion unit 113 performs wavelength conversion and before the wavelength combining switch unit 117 combines a different wavelength after the wavelength conversion.

That is, the optical compensation unit 114 compensates for a predetermined distortion before the wavelength of the same-wavelength optical signal is converted into a different wavelength, and/or compensates for a predetermined distortion after the wavelength of the same-wavelength optical signal is converted into a different wavelength.

The compensators 114a and 114b may use, for example, a waveshaper, such as an optical filter, to compensate for a spectral distortion. Further, the compensators 114a and 114b may use, for example, a dispersion compensating fiber to compensate for a chromatic dispersion (group delay). Each compensator may also include a plurality of dispersion compensation modules in order to be able to compensate for various chromatic dispersions.

The optical signal relay apparatus 11 may include an optical amplifier (AMP) between the input unit 111 and the wavelength selective switch unit 112. The power of the input optical signal is able to be adjusted by the optical amplifier. Further, the optical signal relay apparatus 11 may include another optical amplifier (AMP) between the wavelength combining switch unit 117 and the output unit 116. The another optical amplifier enables increase of the output power. Note that, a portion including the AMP, the wavelength selective switch unit 112, the wavelength combining switch unit 117, and the another AMP may be referred to as a ROADM.

The optical signal relay apparatus 11 performs WDM (wavelength combining) on optical signals of a plurality of wavelengths by the wavelength combining switch unit 117, but at this time, the power of each wavelength may vary.

In order to solve such a problem, the optical signal relay apparatus 11 may perform control by using the optical compensation unit 114 (a filter such as the compensator 114a) in such a way that the power of each wavelength after WDM falls within a range of a predetermined power level in consideration of the variation.

### <Features>

Features of the optical signal relay apparatus 11 will be described below.

### (Compensation of Spectral Distortion)

The spectrum before the input to the wavelength conversion unit and the spectrum after the input are measured preliminary (in advance), the spectral difference between the two is stored in a database for each wavelength, and the compensator (filter) is controlled based on the stored information.

A filter shape for spectral distortion compensation is controlled for each baud rate.

Preliminary measurements may be made a plurality of times.

The compensator (filter shape) is designed considering the wavelength characteristics of a wavelength selective switch (WSS of the preceding stage) and/or a wavelength combining switch (WSS of the following stage).

The compensator is controlled for each wavelength.

The compensator may be controlled for each transducer (or maker or model unit).

### (Compensation for Chromatic Dispersion)

The amount of chromatic dispersion is calculated based on a route (transmission line), wavelength, and optical fiber feature information, and is compensated by a compensator.

When the chromatic dispersion is compensated, the PAPR is lowered and the linearity becomes high, thereby the performance of an analog amplifier may be sufficiently extracted, and the transmission distance is extended.

The function of waveform shaping (the function of distortion compensation of the compensator) may be integrated into the wavelength selective switch (WSS).

A plurality of channels are branched into one port by the WSS of the previous stage, duplicated by a coupler in the WSS of the subsequent stage, and the signal for each channel is extracted by the filter, thereby the number of ports mounted in the WSS is reduced.

A range controllable by a filter (compensator) is controlled in consideration of the power variation for each wavelength after WDM (after wavelength combining).

Control is performed in such a way that when the amount of attenuation by a gain-flattening filter (GFF) of the WSS (wavelength combining switch unit) in the subsequent stage is large, the amount of compensation is increased, and when the amount of attenuation by the GFF is small, the amount of compensation is reduced. At this time, a range in which control is applied may be selected sequentially from important bands (low band and high band).

### <Operation of Optical Signal Relay Apparatus>

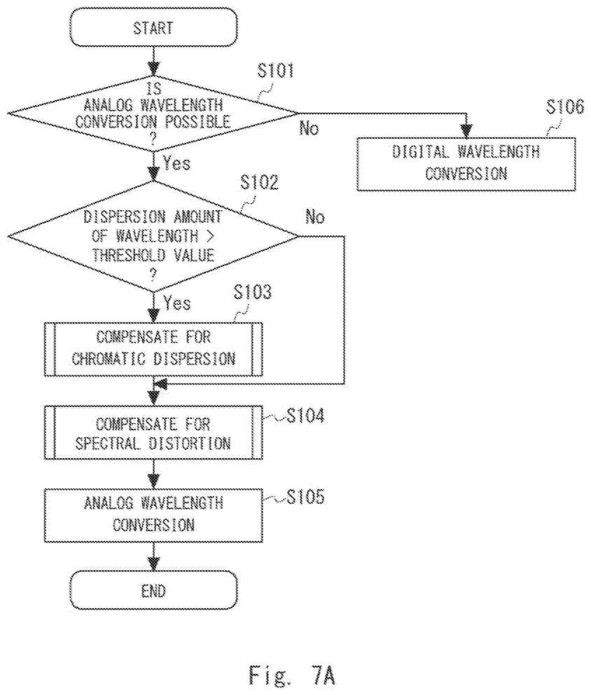

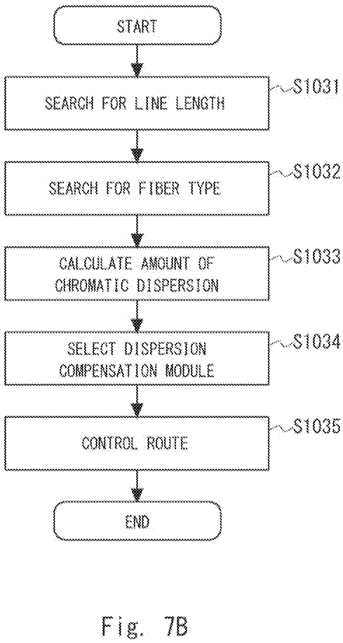

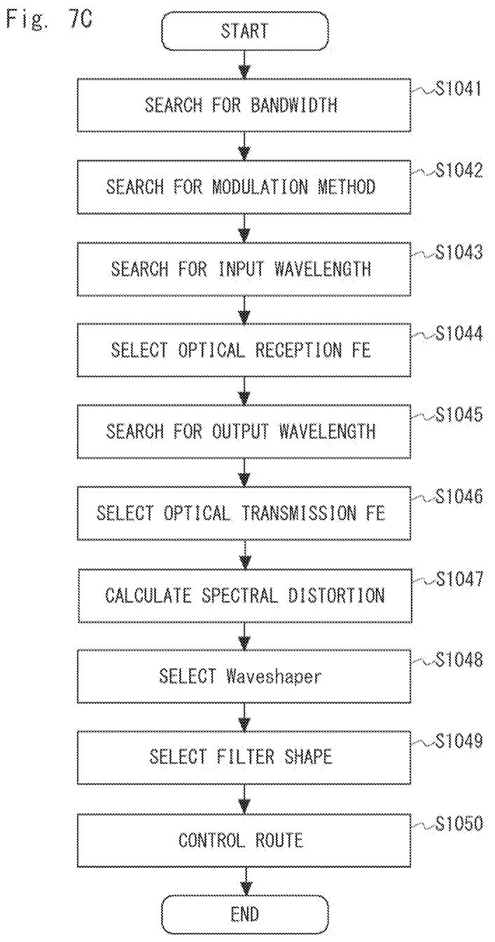

FIG. 7A is a flowchart illustrating an example of an operation of the optical signal relay apparatus according to the first example embodiment.

In FIG. 7A, the spectral distortion is compensated after the chromatic dispersion is compensated, but the present disclosure is not limited thereto. In the first example embodiment, the chromatic dispersion may be compensated after the spectral distortion is compensated.

As illustrated in FIG. 7A, the control unit 115 of the optical signal relay apparatus 11 determines whether analog wavelength conversion is possible (step S101). In the analog wavelength conversion, an optical signal is converted into an electrical signal, and then the electrical signal is converted again, instead of being demodulated, into an optical signal having a wavelength different from that before the conversion.

If it is determined that analog wavelength conversion is possible (step S101: Yes), the control unit 115 determines whether the dispersion amount of the wavelength exceeds the threshold value (step S102).

When the dispersion amount of the wavelength is equal to or less than the threshold value (step S102: No), the control unit 115 does not compensate for the chromatic dispersion, and proceeds to step S104. Since the dispersion amount of the wavelength is small and the effect of the compensation is small, the compensation of the chromatic dispersion is not performed when the dispersion amount is equal to or less than the threshold value.

When the dispersion amount of the wavelength exceeds the threshold value (step S102: Yes), the control unit 115 compensates for the chromatic dispersion (step S103). That is, the control unit 115 controls the optical compensation unit 114 in such a way as to compensate by the amount of dispersion of the wavelength.

In step S103, the control unit 115 compensates for the chromatic dispersion and then compensates for the spectral distortion (step S104).

In step S104, the control unit 115 compensates for the spectral distortion and then performs analog wavelength conversion (step S105).

When the control unit 115 determines in step S101 that the analog wavelength conversion is not possible (step S101: No), the control unit 115 performs digital wavelength conversion (step S106). In the digital wavelength conversion, an optical signal is converted into an electric signal, then reproduced by processing including demodulation and error correction, and the reproduced signal is re-converted into an optical signal having a wavelength different from that before the conversion. Since the processing contents of the digital wavelength conversion may be normally used, the details will not be described herein.

FIG. 7B is a flowchart illustrating an example of an operation of the optical signal relay apparatus according to the first example embodiment.

FIG. 7B illustrates an operation of compensating for a chromatic dispersion, illustrated in step S103 of FIG. 7A.

As illustrated in FIG. 7B, the control unit 115 searches for a line length (step S1031). Specifically, the control unit 115 searches the database for the distance of a transmission section from the optical signal relay apparatus 11 to another optical signal relay apparatus 11n (see FIG. 2).

The control unit 115 searches for a fiber type (step S1032). Specifically, the control unit 115 searches the database for the optical fiber type being used in the transmission section. The material used for the optical fiber and the like is determined according to the optical fiber type.

The control unit 115 calculates the amount of chromatic dispersion (step S1033). Specifically, the control unit 115 compares the retrieved line length (distance) of the transmission section, the retrieved optical fiber type (material), and the wavelength of the optical signal transmitting through the transmission section with a database (see FIG. 5), and calculates the amount of chromatic dispersion.

The control unit 115 selects a dispersion compensation module of the optical compensation unit 114 (step S1034). Herein, the optical compensation unit 114 includes a plurality of compensators, and each compensator includes a plurality of dispersion compensating modules in such a way as to be able to compensate for various chromatic dispersion amounts. The control unit 115 controls the optical compensation unit 114 in such a way as to select, from among the plurality of dispersion compensation modules, an optimal dispersion compensation module for compensating for the amount of chromatic dispersion calculated in step S1033.

The control unit 115 controls a route (transmission line) through which the optical signal is transmitted (step S1035). The control unit 115 controls the route, thereby optical signals having the same wavelength are able to be transmitted to the destination without colliding with each other.

FIG. 7C is a flowchart illustrating an example of an operation of the optical signal relay apparatus according to the first example embodiment.

FIG. 7C illustrates an operation of compensating for a spectral distortion, illustrated in step S104 of FIG. 7A.

As illustrated in FIG. 7C, the control unit 115 searches for a bandwidth of a signal (step S1041). This is because the spectral distortion varies depending on the bandwidth of the signal.

The control unit 115 searches for a modulation method of the signal (step S1042). This is because the spectral distortion varies depending on the modulation method of the signal.

The control unit 115 searches for an input wavelength of an optical signal to be input to the optical signal relay apparatus 11 (step S1043). The input wavelength is, for example, the wavelength λ3 and the like in FIG. 1.

The control unit 115 selects an optical reception front end (FE) (step S1044). The optical reception FE converts an optical signal into an electrical signal by using a light-receiving element.

The control unit 115 searches for an output wavelength (step S1045). The control unit 115 searches for the wavelength being converted by the wavelength conversion unit 113. The output wavelength is, for example, the wavelength λ5 in FIG. 1.

The control unit 115 selects an optical transmission FE (step S1046). The optical transmission FE converts the electrical signal into an optical signal again by using a light-emitting element. Herein, the optical signal before being converted into an electric signal by the optical reception FE and the optical signal after being converted into an optical signal by the optical transmission FE are compared. For example, by comparing the graphs of the waveform before conversion and the waveform without compensation after conversion in FIG. 4, it may be understood that the spectral waveform is different and spectral distortion is generated.

The control unit 115 calculates a spectral distortion (step S1047). Specifically, the control unit 115 compares the bandwidth (transmission rate) retrieved in step S1041, the input wavelength retrieved in step S1043, and the output wavelength (different wavelength) retrieved in step S1045 with the database, and calculates the spectral distortion.

The control unit 115 selects any waveshaper of the optical compensation unit 114 in order to compensate for the spectral distortion calculated in step S1047 (step S1048). The optical compensation unit 114 has a plurality of compensators (see FIG. 6), and each compensator has a plurality of waveshapers in such a way as to be able to compensate for various spectral distortions. The control unit 115 selects, from among the plurality of waveshapers, an optimum waveshaper for compensating for the spectral distortion.

The control unit 115 selects a filter shape (step S1049). In order to compensate for the spectral distortion acquired in step S1047, the control unit 115 selects the filter-shape of the waveshaper selected in step S1048. This reduces spectral distortion.

The control unit 115 controls a route (transmission line) through which the optical signal is transmitted (step S1050). The control unit 115 controls the route, and thereby optical signals having the same wavelength are able to be transmitted to the destination without colliding with each other.

Although the first example embodiment has been described on the assumption that coherent light is used, the present disclosure is not limited to this. The first example embodiment is applicable not only to coherent light but also to incoherent light.

### Second Example Embodiment

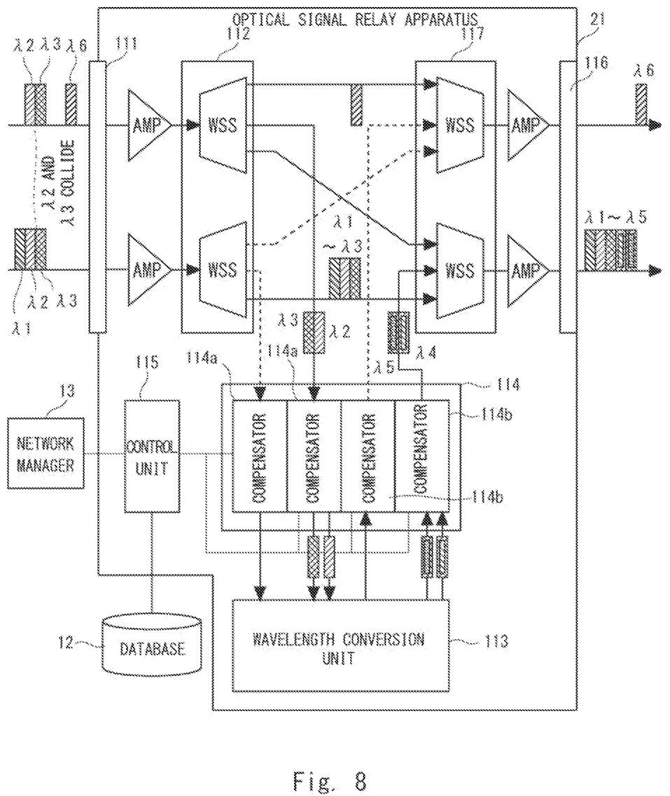

FIG. 8 is a block diagram illustrating an example of an optical signal relay apparatus according to a second example embodiment.

As illustrated in FIG. 8, an optical signal relay apparatus 21 according to the second example embodiment differs from the optical signal relay apparatus 11 according to the first example embodiment in that compensators of an optical compensation unit 114 collectively compensates spectral distortions generated by a plurality of wavelengths. In the present example, compensators 114a and 114b of the optical signal relay apparatus 21 collectively compensate a spectral distortion generated when a wavelength λ2 is converted into a wavelength λ4 and a spectral distortion generated when a wavelength λ3 is converted into a wavelength λ5.

Since the optical signal relay apparatus 21 collectively compensates a plurality of wavelengths, the number of compensators may be reduced.

### Third Example Embodiment

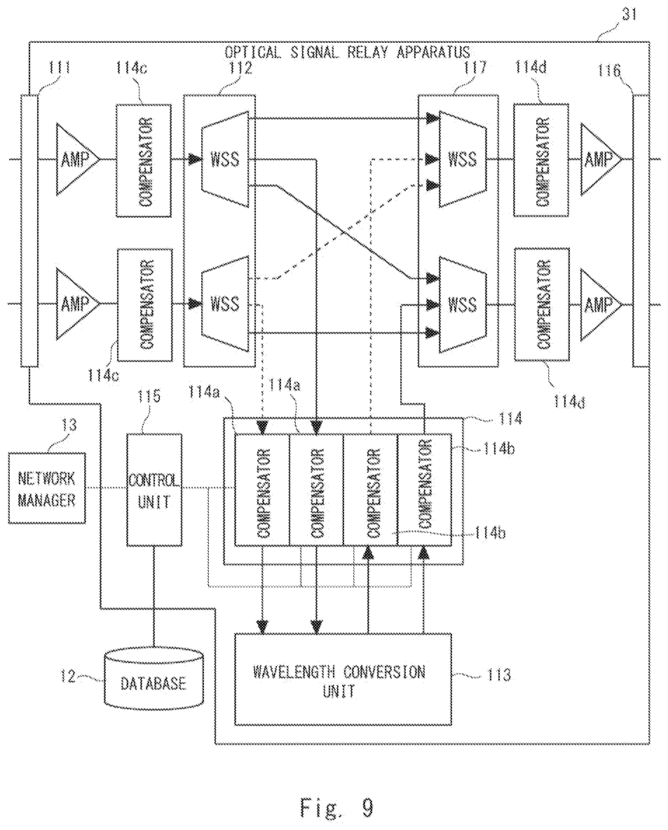

FIG. 9 is a block diagram illustrating an example of an optical signal relay apparatus according to a third example embodiment.

As illustrated in FIG. 9, an optical signal relay apparatus 31 according to the third example embodiment differs from the optical signal relay apparatus 11 according to the first example embodiment in that a compensator 114c is provided between an AMP and a wavelength selective switch unit 112, and a compensator 114d is provided between a wavelength combining switch unit 117 and another AMP.

The compensator 114c is provided before the wavelength is separated by the wavelength selective switch unit 112, and the compensator 114d is provided after the wavelength is combined by the wavelength combining switch unit 117. Thus, the compensators 114c and 114d are able to compensate for spectral distortion and/or chromatic dispersion of a plurality of wavelengths. The optical signal relay apparatus 31 may reduce the number of compensators by collectively compensating for spectral distortions and chromatic dispersions of a plurality of wavelengths.

Further, compensators 114a and 114b are provided after the wavelength is separated by the wavelength selective switch unit 112 and before the wavelength is combined by the wavelength combining switch unit 117. Thus, the compensators 114a and 114b are able to compensate for spectral distortion and/or chromatic dispersion for each wavelength. The optical signal relay apparatus 31 may perform flexible compensation by compensating for spectral distortion and chromatic dispersion for each wavelength.

### Modified Example of Third Example Embodiment

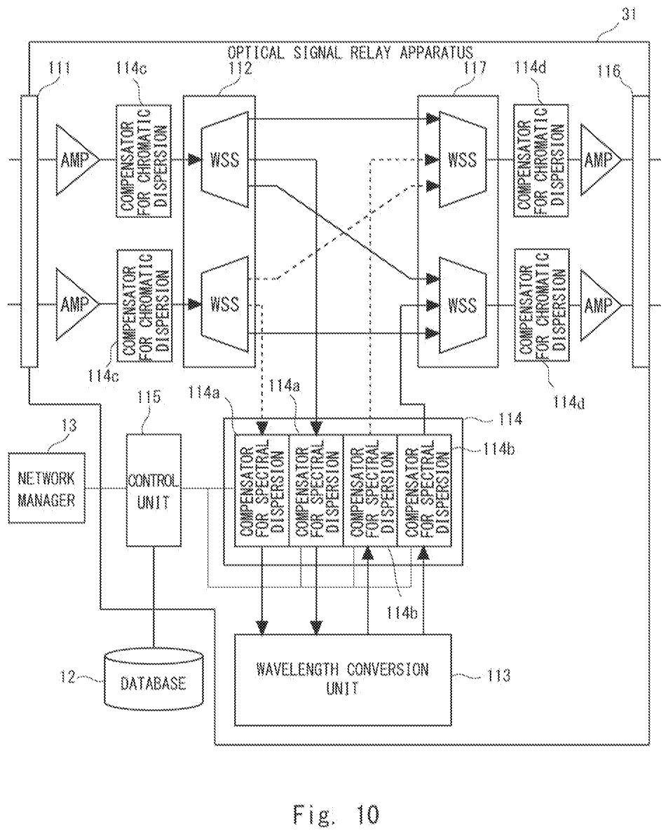

FIG. 10 is a block diagram illustrating an example of an optical signal relay apparatus according to a modified example of the third example embodiment.

As illustrated in FIG. 10, an optical signal relay apparatus 31 uses, for example, spectral distortion compensators for compensating for a spectral distortion as compensators 114a and 114b. Further, the optical signal relay apparatus 31 uses, for example, chromatic dispersion compensators for compensating for a chromatic dispersion as compensators 114c and 114d. At this time, these compensators may be integrated into a WSS.

By using the spectral distortion compensators as the compensators 114a and 114b, spectral distortion is able to be compensated for each wavelength separated by a wavelength selective switch unit 112. Further, by using the chromatic dispersion compensators as the compensators 114c and 114d, chromatic dispersion is able to be compensated for each transmission line.

Although the present disclosure has been described as a hardware configuration in the above-described example embodiments, the present disclosure is not limited thereto. The present disclosure may also be achieved by causing a central processing unit (CPU) to execute a computer program.

In the above-described example embodiments, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Further, although operations are described in a particular order, this should not be understood as requiring that such operations be performed in the particular order or in a sequential order as illustrated, or that all illustrated operations be performed to achieve desirable results. In certain situations, multitasking and parallel processing may be advantageous. Similarly, although details of certain specific example embodiments are included in the above discussion, these should not be construed as limitations on the scope of the present disclosure, but rather as descriptions of features specific to the certain example embodiments. Specific features that are described in the context of separate example embodiments may also be implemented in combination in a single example embodiment. Conversely, various features that are described in the context of a single example embodiment may also be implemented in a plurality of example embodiments separately or in any suitable combination.

An example advantage according to the present disclosure is to provide an optical signal relay apparatus, an optical transmission system, an optical signal relay method, and a program capable of improving the communication quality of a wavelength-multiplexed optical signal.

The first, second, and third example embodiments can be combined as desirable by one of ordinary skill in the art.

Although the present disclosure has been described with reference to the example embodiments, the present disclosure is not limited to the above. Various modifications that can be understood by a person skilled in the art within the scope of the disclosure can be made to the configuration and details of the present disclosure.

The present disclosure is not limited to the above-described example embodiments, and can be appropriately modified without departing from the spirit thereof.

Some or all of the above-described example embodiments may be described as the following supplementary notes, but are not limited thereto.

(Supplementary note 1)

An optical signal relay apparatus including:
an input unit including a first input terminal to which a first optical signal including at least one wavelength is input via a first transmission line, and a second input terminal to which a second optical signal including at least one wavelength is input via a second transmission line;
a wavelength selective switch unit configured to, when a same-wavelength optical signal having the same wavelength as a wavelength included in the second optical signal is present in a wavelength included in the first optical signal, separate the same-wavelength optical signal;
a wavelength conversion unit configured to convert the wavelength of the same-wavelength optical signal into a different wavelength;
an optical compensation unit configured to compensate for a predetermined distortion being generated when converting the wavelength of the same-wavelength optical signal into the different wavelength;
a control unit configured to acquire the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and control the optical compensation unit in such a way as to compensate for the predetermined distortion; and
an output unit configured to output a different-wavelength optical signal including the different wavelength after the predetermined distortion is compensated.

### (Supplementary Note 2)

The optical signal relay apparatus according to supplementary note 1, wherein the database further stores in advance a relationship between a modulation method to be used in modulating an optical signal and the generated distortion.

### (Supplementary Note 3)

The optical signal relay apparatus according to supplementary note 1, wherein the control unit
acquires transmission line information including a distance of a transmission section from the own apparatus to another optical signal relay apparatus, and
acquires a predetermined chromatic dispersion being generated in the transmission section, based on the database that further stores a relationship among a wavelength of an optical signal, a transmission distance, a material of a transmission line, and a chromatic dispersion, the different wavelength, the distance of the transmission section, and the material of the transmission line in the transmission section, and controls the optical compensation unit in such a way as to compensate for the predetermined chromatic dispersion.
   (Supplementary note 4)

The optical signal relay apparatus according to supplementary note 3, wherein the control unit controls the optical compensation unit in such a way as to compensate for the predetermined chromatic dispersion when the predetermined chromatic dispersion exceeds a threshold value.

### (Supplementary Note 5)

The optical signal relay apparatus according to supplementary note 1, wherein the optical compensation unit compensates for the predetermined distortion, before the wavelength of the same-wavelength optical signal is converted into the different wavelength, or compensates for the predetermined distortion, after the wavelength of the same-wavelength optical signal is converted into the different wavelength.

### (Supplementary Note 6)

The optical signal relay apparatus according to supplementary note 1, wherein the optical compensation unit compensates for the predetermined distortion, before the wavelength of the same-wavelength optical signal is converted into the different wavelength, and compensates for the predetermined distortion, after the wavelength of the same-wavelength optical signal is converted into the different wavelength.

(Supplementary note 7)

The optical signal relay apparatus according to supplementary note 1, further including a wavelength combining switch unit configured to combine wavelengths of a part of the first optical signal and a part of the second optical signal and generate a third optical signal, and combine another part of the first optical signal and another part of the second optical signal and generate a fourth optical signal, wherein
the output unit includes a third terminal configured to output the third optical signal and a fourth terminal configured to output the fourth optical signal, and
the different-wavelength optical signal is included in at least one of the third optical signal and the fourth optical signal.

### (Supplementary Note 8)

The optical signal relay apparatus according to supplementary note 1, wherein the apparatus acquires information relating to a wavelength of the same-wavelength optical signal, information relating to the different wavelength, and the transmission rate of the same-wavelength optical signal from a network manager configured to hold information relating to a wavelength of an optical signal being used in the transmission line of an entire optical network.

### (Supplementary Note 9)

The optical signal relay apparatus according to supplementary note 1, wherein the first optical signal and the second optical signal are coherent light.

### (Supplementary Note 10)

The optical signal relay apparatus according to supplementary note 1, further including an optical wavelength detection unit configured to detect whether the same-wavelength optical signal is present in a wavelength included in the first optical signal.

### (Supplementary Note 11)

The optical signal relay apparatus according to supplementary note 1, wherein the different wavelength is a wavelength other than a wavelength of the first optical signal and a wavelength of the second optical signal.

### (Supplementary Note 12)

An optical transmission system including an optical signal relay apparatus and a storage device configured to store information relating to a distortion being generated at a time of wavelength conversion, wherein
the optical signal relay apparatus includes
   an input unit including a first input terminal to which a first optical signal including at least one wavelength is input via a first transmission line, and a second input terminal to which a second optical signal including at least one wavelength is input via a second transmission line,
   a wavelength selective switch unit configured to, when a same-wavelength optical signal having the same wavelength as a wavelength included in the second optical signal is present in a wavelength included in the first optical signal, separate the same-wavelength optical signal,
   a wavelength conversion unit configured to convert the wavelength of the same-wavelength optical signal into a different wavelength,
   an optical compensation unit configured to compensate for a predetermined distortion being generated when converting the wavelength of the same-wavelength optical signal into the different wavelength,
   a control unit configured to acquire the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and control the optical compensation unit in such a way as to compensate for the predetermined distortion, and
   an output unit configured to output a different-wavelength optical signal including the different wavelength after the predetermined distortion is compensated, and
the storage device stores in advance a relationship among the wavelength conversion, a distortion being generated at a time of the wavelength conversion, and the transmission rate of an optical signal.

### (Supplementary Note 13)

The optical transmission system according to supplementary note 12, wherein
the storage device further stores, in the database, a relationship among a wavelength of an optical signal, a transmission distance, a material of a transmission line, and a chromatic dispersion, and
the control unit of the optical signal relay apparatus
   acquires transmission line information including a distance of a transmission section from the optical signal relay apparatus to another optical signal relay apparatus, and
   acquires a predetermined chromatic dispersion being generated in the transmission section, based on the database, the different wavelength, the distance of the transmission section, and the material of the transmission line in the transmission section, and controls the optical compensation unit in such a way as to compensate for the predetermined chromatic dispersion.

### (Supplementary Note 14)

An optical signal relay method including:
separating, when a same-wavelength optical signal having the same wavelength as a wavelength included in a second optical signal including at least one wavelength is present in a wavelength included in a first optical signal including at least one wavelength, the same-wavelength optical signal;
converting a wavelength of the same-wavelength optical signal into a different wavelength;
compensating for a predetermined distortion being generated when converting the wavelength of the same-wavelength optical signal into the different wavelength;
acquiring the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and performing control in such a way as to compensate for the predetermined distortion; and
outputting a different-wavelength optical signal including the different wavelength after the predetermined distortion is compensated.

### (Supplementary Note 15)

A program for causing a computer to execute:
separating, when a same-wavelength optical signal having the same wavelength as a wavelength included in a second optical signal including at least one wavelength is present in a wavelength included in a first optical signal including at least one wavelength, the same-wavelength optical signal;
converting a wavelength of the same-wavelength optical signal into a different wavelength;
compensating for a predetermined distortion being generated when converting the wavelength of the same-wavelength optical signal into the different wavelength;
acquiring the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and performing control in such a way as to compensate for the predetermined distortion; and
outputting a different-wavelength optical signal including the different wavelength after the predetermined distortion is compensated.

What is claimed is:

1. An optical signal relay apparatus comprising:
an input unit including a first input terminal to which a first optical signal including at least one wavelength is input via a first transmission line, and a second input terminal to which a second optical signal including at least one wavelength is input via a second transmission line;
a wavelength selective switch unit configured to, when a same-wavelength optical signal having the same wavelength as a wavelength included in the second optical signal is present in a wavelength included in the first optical signal, separate the same-wavelength optical signal;
a wavelength conversion unit configured to convert the wavelength of the same-wavelength optical signal into a different wavelength;
an optical compensation unit configured to compensate for a predetermined distortion being generated when converting the wavelength of the same-wavelength optical signal into the different wavelength;
a control unit configured to acquire the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and control the optical compensation unit in such a way as to compensate for the predetermined distortion; and
an output unit configured to output a different-wavelength optical signal including the different wavelength after the predetermined distortion is compensated.

2. The optical signal relay apparatus according to claim 1, wherein the database further stores in advance a relationship between a modulation method to be used in modulating an optical signal and the generated distortion.

3. The optical signal relay apparatus according to claim 1, wherein the control unit
acquires transmission line information including a distance of a transmission section from the own apparatus to another optical signal relay apparatus, and
acquires a predetermined chromatic dispersion being generated in the transmission section, based on the database that further stores a relationship among a wavelength of an optical signal, a transmission distance, a material of a transmission line, and a chromatic dispersion, the different wavelength, the distance of the transmission section, and the material of the transmission line in the transmission section, and controls the optical compensation unit in such a way as to compensate for the predetermined chromatic dispersion.

4. The optical signal relay apparatus according to claim 3, wherein the control unit controls the optical compensation unit in such a way as to compensate for the predetermined chromatic dispersion when the predetermined chromatic dispersion exceeds a threshold value.

5. The optical signal relay apparatus according to claim 1, wherein the optical compensation unit compensates for the predetermined distortion, before the wavelength of the same-wavelength optical signal is converted into the different wavelength, or compensates for the predetermined distortion, after the wavelength of the same-wavelength optical signal is converted into the different wavelength.

6. The optical signal relay apparatus according to claim 1, wherein the optical compensation unit compensates for the predetermined distortion, before the wavelength of the same-wavelength optical signal is converted into the different wavelength, and compensates for the predetermined distortion, after the wavelength of the same-wavelength optical signal is converted into the different wavelength.

7. The optical signal relay apparatus according to claim 1, further comprising a wavelength combining switch unit configured to combine wavelengths of a part of the first optical signal and a part of the second optical signal and generate a third optical signal, and combine another part of the first optical signal and another part of the second optical signal and generate a fourth optical signal, wherein
the output unit includes a third terminal configured to output the third optical signal and a fourth terminal configured to output the fourth optical signal, and
the different-wavelength optical signal is included in at least one of the third optical signal and the fourth optical signal.

8. The optical signal relay apparatus according to claim 1, wherein the apparatus acquires information relating to a wavelength of the same-wavelength optical signal, information relating to the different wavelength, and the transmission rate of the same-wavelength optical signal from a network manager configured to hold information relating to a wavelength of an optical signal being used in the transmission line of an entire optical network.

9. The optical signal relay apparatus according to claim 1, wherein the first optical signal and the second optical signal are coherent light.

10. The optical signal relay apparatus according to claim 1, further comprising an optical wavelength detection unit configured to detect whether the same-wavelength optical signal is present in a wavelength included in the first optical signal.

11. The optical signal relay apparatus according to claim 1, wherein the different wavelength is a wavelength other than a wavelength of the first optical signal and a wavelength of the second optical signal.

12. An optical transmission system comprising an optical signal relay apparatus and a storage device configured to store information relating to a distortion being generated at a time of wavelength conversion, wherein
the optical signal relay apparatus includes
an input unit including a first input terminal to which a first optical signal including at least one wavelength is input via a first transmission line, and a second input terminal to which a second optical signal including at least one wavelength is input via a second transmission line,
a wavelength selective switch unit configured to, when a same-wavelength optical signal having the same wavelength as a wavelength included in the second optical signal is present in a wavelength included in the first optical signal, separate the same-wavelength optical signal,
a wavelength conversion unit configured to convert the wavelength of the same-wavelength optical signal into a different wavelength,
an optical compensation unit configured to compensate for a predetermined distortion being generated when converting the wavelength of the same-wavelength optical signal into the different wavelength,
a control unit configured to acquire the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and control the optical compensation unit in such a way as to compensate for the predetermined distortion, and
an output unit configured to output a different-wavelength optical signal including the different wavelength after the predetermined distortion is compensated, and
the storage device stores, in the database in advance, a relationship among the wavelength conversion, a distortion being generated at a time of the wavelength conversion, and the transmission rate of an optical signal.

13. The optical transmission system according to claim 12, wherein
the storage device further stores, in the database, a relationship among a wavelength of an optical signal, a transmission distance, a material of a transmission line, and a chromatic dispersion, and
the control unit of the optical signal relay apparatus
acquires transmission line information including a distance of a transmission section from the optical signal relay apparatus to another optical signal relay apparatus, and
acquires a predetermined chromatic dispersion being generated in the transmission section, based on the database, the different wavelength, the distance of the transmission section, and the material of the transmission line in the transmission section, and controls the optical compensation unit in such a way as to compensate for the predetermined chromatic dispersion.

14. An optical signal relay method comprising:
separating, when a same-wavelength optical signal having the same wavelength as a wavelength included in a second optical signal including at least one wavelength is present in a wavelength included in a first optical signal including at least one wavelength, the same-wavelength optical signal;
converting a wavelength of the same-wavelength optical signal into a different wavelength;
compensating for a predetermined distortion being generated when converting the wavelength of the same-wavelength optical signal into the different wavelength;
acquiring the predetermined distortion, based on a database that stores in advance a relationship among the wavelength conversion, a distortion being generated at a time of the wavelength conversion, and a transmission rate of an optical signal, the wavelength of the same-wavelength optical signal, the different wavelength, and the transmission rate of the same-wavelength optical signal, and performing control in such a way as to compensate for the predetermined distortion; and
outputting a different-wavelength optical signal including the different wavelength after the predetermined distortion is compensated.
